(19) United States
(12) Patent Application Publication
(10) Pub. No.: US 2009/0281905 A1
(43) Pub. Date: Nov. 12, 2009

(54) System and method for charitable donations

(76) Inventor: Daniel B. Walton, Oklahoma City, OK (US)

Correspondence Address: Harvey & Associates, P.C., 321 84th Avenue NE, Norman, OK, 73026, US

(21) Appl. No.: 11/043,489

(22) Filed: Jan. 26, 2005

Related U.S. Application Data
(60) Provisional application No. 60/540,415, filed on Jan. 30, 2004.

(51) Int. Cl. G06Q 30/00; G06Q 40/00; G06Q 10/00; G06Q 20/00; G06Q 50/00; G06F 17/30; G06F 3/048

(52) U.S. Cl. 705/26; 705/35; 705/30; 707/104.1; 707/E17.044; 707/3; 707/E17.108; 715/840

(57) ABSTRACT

A method and system is provided, in which an interfacing device is distributed free by a value net integrator to end users, or supporting parties, whose normal use thereof may benefit a soliciting entity, such as a charity or social group, through various forms of interactive advertising, combined with an interactive and good will based referral incentive program. The interfacing device may comprise a special toolbar to identify and locate the participating third party vendors; to enable supporting parties to access a search engine partner for Internet searches, where the search engine partner agrees to provide a commission to the value net integrator on a per-click basis; and to allow supporting parties to easily make direct contributions to the soliciting entity. The special toolbar may provide additional value to encourage its use by the supporting parties, such as providing an intelligent pop-up blocking capability. The value net integrator may collect the commissions generated by the supporting party's use of the special toolbar, pay a royalty to the soliciting entity out of the commissions on a periodic basis, and retain the remainder as compensation for its services.

### CROSS-REFERENCES TO RELATED APPLICATIONS

This patent application claims the benefit of U.S. Provisional Application No. 60/540,415, filed Jan. 30, 2004, of similar title.

### BACKGROUND OF THE INVENTION

The present invention relates to a method of charitable giving. More specifically, the present invention relates to the use of a software interfacing device to provide a continuous stream of revenues to the charitable organization from users of the interfacing device.

A number of charitable groups exist to promote various causes such as helping the poor or developing a cure of a specific disease. Such charities may include, but are not limited to, the United Way, the Salvation Army, the American Red Cross, the American Cancer Society, the American Heart Association, disabilities organizations, and church or faith-based groups. In many instances, these groups do an excellent job of helping those in need. However, they all have the common problem of securing funds to provide charitable services, to operate, and to pursue its benevolent goals.

The primary method for charitable groups to secure funds is through solicitation of donations. There are numerous methods for securing donations. A donor, i.e. a supporting party that wishes to support the goals and direction taken by the charitable group, may be directly solicited by common methods, such as telephone solicitations, television telethons, radio advertising, letters and flyers, awards banquets, and the like. So-called “split gifts” may be set up, where the distribution to the charitable group is deferred until the death of the supporting party; in many cases, years may pass before the charitable group actually receives any money. In other situations, the supporting party may donate securities or art objects to the charitable group in order to take a tax deduction. Each of these methods has its own advantages and disadvantages, which will not be discussed here.

New methods that employ a global communications system, such as the Internet, for soliciting and receiving donations have also been developed. One such method is disclosed in U.S. Pat. No. 6,581,041, where the supporting party makes deposits to a financial account over the Internet, and a pre-negotiated percentage is paid to a selected charitable group for each transaction. In this way the supporting party may divert a portion of the supporting party's investments in a savings program to the charity without unnecessary paperwork or bother. However, the supporting party must be willing to set up the financial account and to engage in a certain amount of effort to ensure that the periodic donations take place.

All of these methods require a financial outlay on the part of the charitable group, whether it is in terms of marketing fees paid to third parties for fund solicitation, management time and effort, stamps, or materials, and this financial outlay necessarily reduces the effective amount of the funds retained by the charity, since a portion of the funds received must go towards these costs incurred. Furthermore, there are other ways in which the supporting party can benefit the charitable group without actually donating money or assets. For example, the supporting party may patronize a business by purchasing goods or services, and the business in turn agrees to benefit the charitable group in some manner in recognition of such patronization.

What is needed is a new method for benefiting a charitable group, where the method (1) does not reduce the amount of the funds received by the charitable group due to up front financial outlays, (2) is easily implemented without requiring an excessive expenditure of time and funds, and (3) can be easily extended to other supporting parties.

### SUMMARY OF THE INVENTION

A business system is provided for collection of charitable donations made by a supporting party to a soliciting entity, where the system comprises a business entity; a first contractually specified interface between the business entity and a third party vendor which comprises an agreement where the business entity agrees to provide an interfacing device that directs the supporting party to the third party vendor for the purchase by the supporting party of goods provided by the third party vendor and the third party vendor agrees to pay to the business entity a royalty based on each sale made to the supporting party; a second contractually specified interface between the business entity and a soliciting entity which comprises an agreement where the business entity provides to the soliciting entity an interfacing device referencing the third party vendor, the interfacing device is provided to the supporting party that wishes to benefit the soliciting entity, and the business entity provides to the soliciting entity a percentage of royalty provided by third party vendor, the royalty being derived from sales made to the supporting party that makes a sales transaction with the third party vendor through the interfacing device and purchases goods and services therefrom; a third contractually specified interface between the business entity and a search engine entity, where the business entity receives payments from the search engine entity for each reference made by the supporting party to the search engine entity through the interfacing device; and a fourth contractually specified interface between the soliciting entity and the supporting party where the soliciting entity provides the interfacing device to the supporting party and the supporting party uses the interfacing device to access the third party vendor and the search engine entity.

In another embodiment of the invention, a business system is also provided for collection of charitable donations made by a supporting party to a soliciting entity, where the system comprises a business entity; a soliciting entity; a third party vendor; a first contractually specified interface with the third party vendor comprising an agreement in which the business entity agrees to provide an interfacing device that directs the supporting party to the third party vendor for the purchase by the supporting party of goods provided by the third party vendor and the third party vendor agrees to pay to the business entity a royalty based on each sale made to the supporting party; a second contractually specified interface between the business entity and the soliciting entity comprising an agreement in which the business entity provides to the soliciting entity the interfacing device referencing the third party vendor, the interfacing device is provided to the supporting party that wishes to benefit the soliciting entity, and the business entity provides to the soliciting entity a percentage of royalty provided by third party vendor, the royalty being derived from sales made to supporting party that makes a sales transaction with the third party vendor through the interfacing device and purchases goods and services therefrom; and a third contractually specified interface between the soliciting entity and the supporting party in which the soliciting entity provides the interfacing device to the supporting party and the supporting party uses the interfacing device to access the third party vendor.

In another embodiment of the business system, the third party vendor may be a search engine entity.

A method of charitable donations is provided, where the method comprises the steps of establishing a business arrangement between a value net integrator and the soliciting entity; providing an interfacing device with features selected by the soliciting entity; establishing business relationships between the value net integrator and one or more third party vendors each having an interest in the soliciting entity; introducing the interfacing device into a stream of commerce; using of the interfacing device by a supporting party to purchase goods and services; and making a royalty payment by the value net integrator to the soliciting entity where the payment comes from the commissions collected by the value net integrator from third party vendor payments and search engine partners.

In another embodiment of the invention, the interfacing device may be a toolbar configured with functions chosen by the soliciting entity, which enable the value net integrator to generate and collect revenues from third party vendors and/or search engine partners.

In still another embodiment of the invention, the interfacing device may be a configuration program that configures the browser of the supporting party to access a specially-formatted web page as the home page for the browser.

In yet another embodiment of the invention, the interfacing device may be implemented into the stream of commerce by the supporting party, where the supporting party downloads the specially configured toolbar from either the website of the soliciting entity or the value net integrator.

In another embodiment of the invention, a means may be provided to reward supporting parties that distribute and encourage the use of the special toolbar by other supporting parties that register their special toolbars with the value net integrator.

These and other features, aspects, and advantages of the present invention will become better understood with reference to the following drawings, description, and claims.

### BRIEF DESCRIPTION OF THE DRAWINGS

FIG. 1 shows an example of the appearance of a toolbar within the window of a typical browser, according to an embodiment of the invention;

FIG. 2 is a flowchart of an embodiment of a method of charitable donations according to the present invention; and

FIG. 3 is a block diagram showing the interactions between the entities comprising the system, according to an embodiment of the present invention.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims.

The invention provides a system and method for a soliciting organization, or entity, to receive contributions, donations, payments, or benefits that result from Internet transactions that are made by the supporting parties that use the method. It may also provide a way for the supporting party to indirectly benefit the soliciting organization by purchasing goods and services from participating third party vendors that participate in the system and method, which then make a portion of their receipts resulting from the transaction available to the soliciting organization. An interfacing device may be used as the vehicle for making the contributions, donations, benefits, or payments. The interfacing device may be implemented as a toolbar that captures or otherwise accounts for such payments that result from periodic uses of the toolbar by the supporting party for searches, purchase of goods from participating vendors, or direct donations in which the total amount of the donation is directed to the soliciting entity. An advantage of the toolbar is that it may be attached to and invoked from another software process on the supporting party's computer without extensive software modification of the invoking program. Another way of implementing the interfacing device may be to format a special web page that may be designated as the home page of the supporting party's internet browser and to directly invoke through the special web page's capabilities the same functions as are referenced by the toolbar.

A toolbar is a term used with relation to software products operating within the Windows operating system, where Windows is a registered trademark of the Microsoft Corporation, and similar operating systems that incorporate the Windows concept. It is defined as a row, column, or block of onscreen buttons or icons that, when selected or “clicked”, activate certain functions of a program with which the toolbar is related. For example, a word processor may have a standard toolbar that includes buttons for changing text to italic, bold, or other styles. An Internet browser, such as the Internet Explorer provided by Microsoft Corporation or Netscape provided by Netscape Communications Corporation, may have a toolbar devoted to email-related functions such as read, forward, or delete. A toolbar may be made available to the host software for display within the operating window used by the host software as a convenient way for a supporting party to execute program functions.

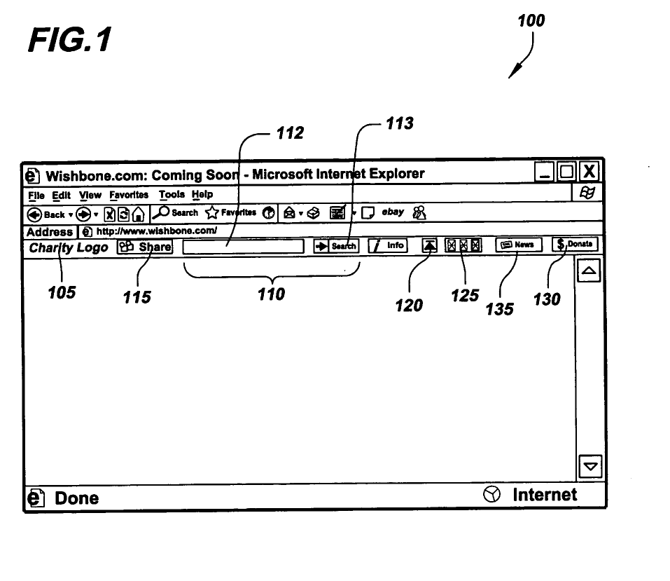

In a system of charitable donations according to the invention, a special charitable toolbar may be configured to contain functions that are specific to a charitable group that may be the soliciting entity. An example of such a toolbar 100 may resemble the embodiment shown in FIG. 1. The toolbar may typically feature a logo 105 of the soliciting entity for identification and/or branding purposes. Typical functions that might be included on the toolbar may be the following:
1. A button directing the supporting party to a website of participating vendors that have agreed to contribute a certain percentage of any transaction for goods or services to a financial account for the benefit of the charitable group.
2. A donation button 130 for directing a specific donation to the financial account of the charitable group.
3. A news button 135 for displaying items of interest that pertain to the charitable activities of the charitable group.
4. A group of search buttons 110 for performing a search of Internet websites, where the search facility is provided by a participating search services vendor that has signed an agreement given according to the business method that shall be described presently. These buttons may be divided into a text box 112 for giving keyword upon which the search is performed and an activation button 113 that initiates the search.
5. A button for joining a chat group of supporting parties that are interested in sharing information regarding the charitable group or its charity.
6. A share button 115 that would enable a supporting party to send an email to a selected party to inform that party about the benefits of using the toolbar.
7. A popup blocker enable button 120 that would allow the supporting party to turn on and turn off a popup blocker feature incorporated within the toolbar.
8. A blocked popup counter 125 showing the number of popup windows that the toolbar has blocked.

Alternatively, a specially-formatted web page may be provided as an interfacing device according to the business method, where the functions of the specially-formatted web page include the functions contemplated for a toolbar. According to this embodiment, such a web page may be designated as the home page for the supporting party's browser, so that each time the supporting party invokes the browser to access the Internet, these functions may be provided along with other information and links that are pertinent to the soliciting entity. In either case, the it is preferable to provide the interfacing device free of charge to the supporting party as an added inducement to use the interfacing device; however, it may also be provided under license or in exchange for a fee as the situation warrants, without departing from the scope of the invention.

A central concept of the business method is that the supporting party can configure an interfacing device into its typical web access activities, so that the supporting party may conveniently support a soliciting entity monetarily both directly and indirectly and in particular, support a charity, by using the features of the interfacing device to perform the supporting party's activities on the Internet, such as browsing websites or purchasing goods and services, and that the supporting party is motivated to use the toolbar because of the extra value provided by special features associated with the interfacing device, or toolbar. A soliciting organization may induce the supporting party to use the toolbar by incorporating extra value features within the toolbar that make it desirable to the supporting parties. One of many such ways to provide such extra value may be to provide a capability to block pop-ups, i.e. windows that are sent to the supporting party's browser, or that “pop-up” without being specifically invoked, for display to the supporting party while the supporting party is interacting with the internet. Such a pop-up blocker may have value-added features such as an intelligent differentiation between wanted and unwanted pop-ups. Thus, unwanted advertising pop-ups may be blocked without interfering with site navigation pop-ups. This value-added feature may distinguish the pop-up blocker provided in the current business method from similar technologies provided by large Internet Service Providers (ISP) that take an all-or-nothing approach to pop-up blocking, which can hamper the supporting party's web site navigation. Other extra value features well known by practitioners in the current art may also be provided without departing from the scope of the invention. As the art evolves, it is expected that other extra value features may be conceived and added to the current toolbar concept.

A toolbar may also be provided with special visual features that differentiate the soliciting entity's toolbar from similar toolbars from other organizations. Special banners, logos, color combinations, and the like may be provided to specifically identify the association between the special tool bar and the soliciting entity, which may enhance name recognition and provide branding in the marketplace.

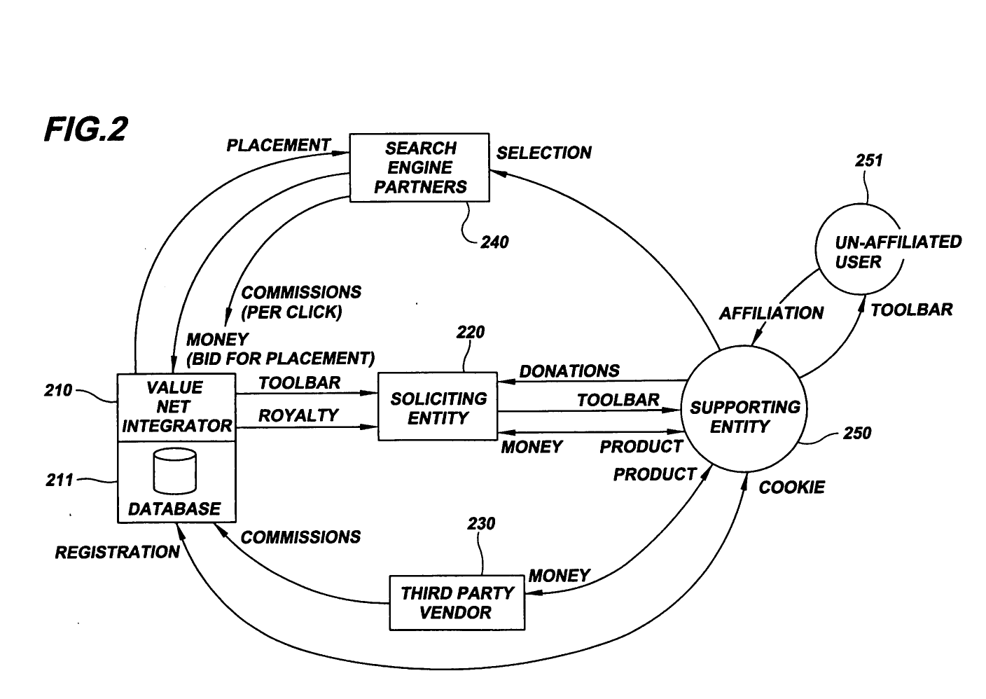

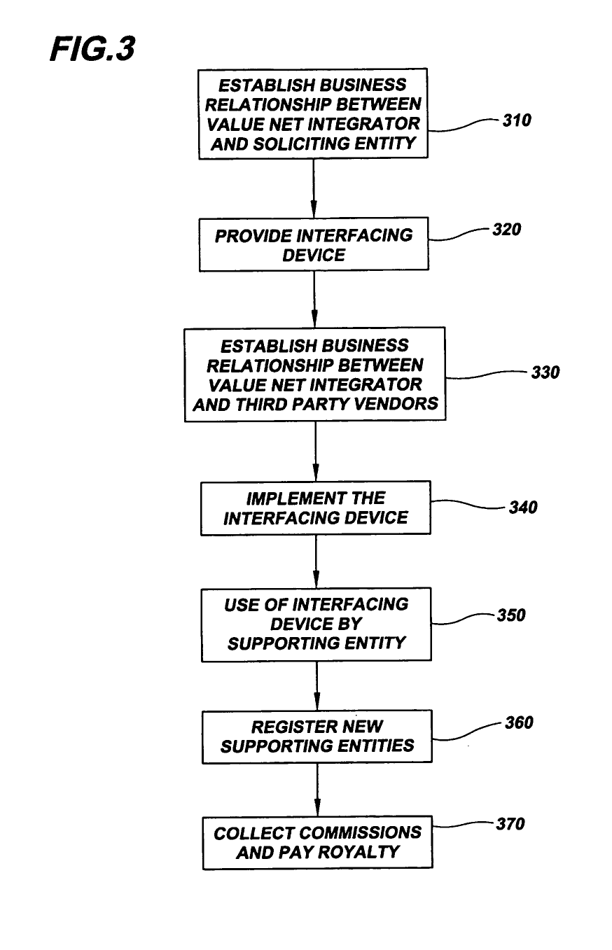

A particular embodiment of the method of the invention is shown in FIGS. 2 and 3. According to the figures, a number of entities may be involved in the various transactions comprising the method. A soliciting entity 220 may be the organization, group, foundation, or entity that wishes to benefit its organizational goals. For example, a charitable organization may solicit funds for supporting a charitable cause such as the feeding of disadvantage children, furthering cancer research, or assisting people with disabilities. An educational organization may solicit funds for the purpose of providing grants to students or funding educational chairs of a given educational institution. A sports related organization may solicit funds for the purpose of building sports stadiums. Special interest groups, such as the Sierra Club or the National Arbor Day Other organizations that have an interest in soliciting funds may employ the method of the invention without departing from its scope.

The supporting party 250 may be another organization or person that wishes to benefit the charitable, educational, or sports related cause championed by the soliciting entity. The supporting party 250 may be an individual person or another organization that has expressed an intent to donate to the soliciting entity 220 according to the method that will be presently described. The typical user or non-supporting party 251 may be a person or organization that has not yet accepted the terms of use or the goals of the soliciting entity 220 but may be convinced to do so by availing itself of the benefits of the interfacing device provided by the soliciting entity 220 and a business entity designated as a value net integrator 210, thus becoming an supporting party 250 thereby.

The business entity, or value net integrator 210, may be the entity that manages the process and provides fund collection services to the soliciting entity 220, such services that may include, but are not limited to, providing a specially configured interfacing device for use by the soliciting entity 220 and the supporting party 250, providing data collection and maintenance of a database of supporting parties 250 that become associated with the soliciting entity 220, and contacting third party vendors 230 for participation according to the method. The Value net integrator 210 may provide such services for a fee that may be paid directly by the soliciting entity 220 or by Third party vendors 230 and Search Engine Partners 240 who wish to benefit from the marketing, name recognition, and exposure provided by inclusion on the interfacing device functions.

The Third party vendor(s) 230 may be a commercial person or organization that provides goods or services for payment and use by the supporting party 250, but also provides a payment to the Value net integrator 210 in the form of a royalty, commission, or percentage of the sale of goods or services to the supporting party 250. Similarly, the Search Engine Partner(s) 240 may provide search services for use by the supporting party 250 and pay the soliciting entity 220 a royalty or commission based upon usage of its services by the supporting party 250. Other payment arrangements such as a flat fee to be paid on a periodic basis may also be used without departing from the scope of the invention.

The method may have seven steps as shown in FIG. 3. The first step as shown by the box indicated as 310 may be to set up a business arrangement between a Value net integrator 210 and a soliciting entity 220. The Value net integrator 210 may control the business process and provide services to the soliciting entity 320, namely, providing an interfacing device in the form of either a special toolbar or a specially formatted web page, either of which may be configured to the requirements of the soliciting entity 220, and maintaining records of supporting parties 250 who download or access the interfacing device. The Value net integrator 210 may also market the business concept to vendors who wish to participate in the business arrangement. The value net integrator 210 may pay a royalty to the soliciting entity 220 based upon the income it derives from commissions it receives from various business entities that are promoted through the functions of the interfacing device. The Value net integrator 210 pays the soliciting entity 220 the royalty for using the name of the soliciting entity 220 and providing facilities, i.e. the website platform of the soliciting entity 220, to distribute the interfacing device. The soliciting entity 220 may monitor the use of its name and style of presentation by the interfacing device. The Value net integrator 210 and the soliciting entity 220 may agree to a reasonable royalty to be paid to the soliciting Entity 220 out of the revenues collected by the value net integrator 210.

The second step as shown by the box indicated as 320 may be to provide an interfacing device with desirable features pertinent to the soliciting entity 220. When the interfacing device is a toolbar, the value net integrator 210 may create a special, organization-specific toolbar for distribution by the soliciting entity 220 from its website. The soliciting entity 220 may provide the value net integrator 210 with a list of the features that it desires to provide to those who have an interest in the activities promoted by the soliciting entity 220. The value net integrator 210 may alternatively provide the soliciting entity 220 with a list of suggested functions that are pertinent to activities and that have been proven to be useful in other such arrangements.

The third step as shown by the box indicated as 230 may be the establishment of business relationships between the value net integrator 210 and third party vendors 230 that have an interest in the soliciting entity 220. Such business relationships might be in the form of an agreement or contract in which the third party vendor 230 agrees to pay a commission to the value net integrator 210 for each sale of a product provided by the third party vendor 230 that results from the supporting party's use of the interfacing device. In the case of a special toolbar, special buttons may be configured to direct the supporting party to the website of the third party vendor 230. Alternatively, a button may be provided to direct the supporting party to web page configured as a virtual shopping mall where all participating third party vendors 230 may either have links to their individual websites or have display pages describing items specially made for use of the supporting parties, e.g. sweatshirts with emblems and/or logos of the soliciting entity 220 imprinted on them. In the case where the third party vendor 230 may provide a service that might be free to the supporting party, e.g. a search, the agreement or contract might provide for payment of a fixed sum to the value net integrator 210 for each invocation of the third party vendor's 230 service by the supporting party.

The fourth step as shown by the box indicated as 340 may be the introduction of the interfacing device into the stream of commerce. The interfacing device may be provided by the soliciting entity 220 through its standard soliciting activities. For example, if the soliciting entity periodically sends out newsletters to its supporters, the soliciting entity may provide information about the availability of the interfacing device. Information about the interfacing device may also be provided through standard brochures and advertisements of the soliciting entity 220. In the case of a specially configured toolbar, a downloadable file may be provided on the website of the soliciting entity 220 or a privately branded sub-site that is a part of the value net integrator 210's website. In the latter case, the downloadable file may simply be an installer program that may change the profile of the supporting party's browser to reference the website. An informational screen or web page may be provided by the soliciting entity 220 through its soliciting activities to introduce the special toolbar to potential supporting parties 250, explain its features, and describe how use of the toolbar may benefit the soliciting entity 220. The soliciting entity 220 may also promote use of the interfacing device through informational advertisements in its promotional literature, advertisements, and other such media notices.

The fifth step as shown in the box indicated as 350 may be the use of the interfacing device by the supporting party. In the case of a special toolbar, this step may consist of the supporting party downloading and installing the special toolbar with the knowledge that use of the toolbar functions will benefit the soliciting entity 220. The supporting party may be encouraged to provide the toolbar file to others and encourage them to also use the toolbar. Supporting parties wishing to benefit the soliciting entity 220 may use the facilities provided by the toolbar and patronize the third party vendors 230 associated with the toolbar, with the knowledge that a portion of their purchase of goods or services will be received by, and thus benefit, the soliciting entity 220.

When the interfacing device is a specially-configured toolbar, the toolbar may provide a number of features that benefit the soliciting entity 220. These may be, but are not limited to, the following:
1. A search feature may be provided for the soliciting entity 220; in some embodiments, the search feature may be the primary means of revenue generation. The value net integrator 210 and a special third party vendor 230, designated as a search engine partner 240, may enter into an agreement such that the search engine partner 240 may provide a search function for use on the toolbar. The search engine partner 240 may in turn provide high quality search listings and sponsored links. In one aspect of the invention, the sponsored links may generate revenue to the soliciting entity 220 on a per-click through basis. Sponsors may bid on a per-click through basis for positions closer to the top of the search results for any given search term. This system, called pay-for-placements, may provide marketers with a way to attract highly targeted audiences at the right time for a small investment. Each supporting party 250 that uses the search capabilities may, by accessing the sponsored links, cause the sponsor to pay a small amount to the value net integrator 210 for each click-through made by the supporting party 250. At the end of the month or some other designated period, the value net integrator 210 may pay the soliciting entity 220 a royalty based upon the revenues received from these operations and retain the remainder as profit. In another embodiment of the invention, the search engine partner 240 may pay the value net integrator 210 a monthly fee. Other payment options may be used to provide compensation to the value net integrator 210 by the search engine partner 240 without departing from the scope of the invention.
2. A virtual shopping mall may be provided, consisting of third party vendors 230 (“online merchants”) who offer commissions to the value net integrator 210 for directing supporting parties to the virtual shopping mall. The virtual shopping mall may be accessible through an icon or button associated with the interfacing device. Purchase of goods and services made through many of the interfacing device's linked affiliate programs could produce a significant revenue stream to the soliciting entity 220 when the supporting parties learn that online purchases made in this manner will cost them no more than purchases made otherwise, but will benefit the soliciting entity 220. Again, the value net integrator 210 may collect commissions and on a monthly basis, pay the soliciting entity 220 its royalty, and retain the remainder as profit.
3. The soliciting entity 220 may itself offer products on the virtual shopping mall in the same manner as the online merchants. However, purchases made from the soliciting entity 220 would flow directly to the soliciting entity 220 and thus bypass the value net integrator 210. The Soliciting entity 220 would be responsible for providing records to the supporting party for tax purposes, in which a portion of the purchase is identified as payment for value received and a portion is identified as a donation.
4. A function may be provided by the interfacing device to make direct online donations, payments, or contributions to the soliciting entity 220 by means of supporting party's credit card or other online payment mechanism. Again, such donations would go directly to the soliciting entity 220 and bypass the value net integrator 210 and the soliciting entity 220 would be responsible for providing a donation receipt to the supporting party.

The sixth step as shown by the box indicated as 360 may be to register new users 251 who have implemented the interfacing device and thus become supporting parties 250. In the case of a special toolbar, the special toolbar may contain a feature that would require it to be registered in order to enable its features. Registration may consist of an automatic message sent to the website or server of the value net integrator 210 by the interfacing device, where the message would contain information about the supporting party. This may allow the value net integrator 210 to (1) keep track of how many supporting parties are using the special toolbar, and (2) implement a rewards program for supporting parties who spread and encourage the use of the special toolbar among their friends. Implementation of a rewards program may resemble the standard network marketing concept that is presently in use in the Multi-Level Marketing industry.

The seventh step as shown by the box indicated as 370 may be to pay the soliciting entity 220 its royalty payment from the commissions collected from third party vendor 230 payments and search engine partners. In this way, the value net integrator 210 may receive compensation for facilitating the services, putting the marketing program in place, and for maintaining the toolbar as different operating systems and browsers evolve.

It should be understood that although the steps presented above have necessarily been presented in a particular order to facilitate the description of the inventive method, such an order should not imply that the steps must be performed in the order presented. Other ordering of the steps of the method may be executed and still remain within the scope of the invention.

FIG. 2 shows the typical interactions that may occur between the different participants of a typical embodiment of the method on a global communications network, or Internet. The value net integrator 210 may serve to collect all revenues from the participating third party vendors 230 and the search engine partners 240 and to pay a royalty to the soliciting entity 220 for its use of the name, cooperation, and promotion of the business method. The supporting parties 250 may configure the interfacing device provided either by the soliciting entity 220 or the value net integrator 210. The supporting party 250 may also encourage and promote the use of the interfacing device to non-supporting parties 251, who in turn may become supporting parties 250 when they obtain and register the interfacing device. The supporting party 250, by using the toolbar, may direct donations directly to the soliciting entity 220, purchase goods directly from the soliciting entity 250, purchase goods/services from third party vendors 230, or perform searches through search engine partners 240. The value net integrator 210 may maintain a database 211 of registrations so that an incentive program may be optionally provided to encourage supporting parties 250 to promote and encourage the use of the interfacing device. One embodiment of such an incentive program may involve returning to the supporting party 250 a portion of the commission received by the value net integrator 210 that is generated by purchases made by users 251 who have now become supporting parties 250.

Other permutations of the above-mentioned entities may be contemplated as being within the scope of the invention. For example, the value net integrator 210 and the soliciting entity 220 may be the same entity if the soliciting entity 220 chooses to undertake the task of developing its own interfacing device. Also, use of the term “charitable organization” should not suggest that the inventive method may only be applied such organizations. Other entities, such as educational institutions and financial institutions, may also implement this method with minor variations and still be within the scope of the invention. Furthermore, the search engine partner 240 and the value net integrator 210 may be the same organization, with the search engine partner 240 providing interfacing device based upon its own toolbar concept. Other obvious modifications to the inventive business method may also be made without departing from the scope of the invention.

In still another permutation, the value net integrator 210 may initiate and manage a charitable program, with the charities that are benefited taking a passive role. The value net integrator 210 may develop a list of worthy, legitimate organizations and provide the supporting party 250 with an option within the interfacing device of choosing or designating an organization from the list to receive benefit of the supporting party's 250 use of the interfacing device for transactions. The value net integrator 210 may then market the interfacing device and make agreements with third party vendors 230, search engine partners 240, or some combination thereof to participate in the program. The third party vendors 230 would agree to remit to the value net integrator 210 a portion of the receipts they receive from transactions made by supporting parties 250 using the interfacing device, where the transaction results in a sale of goods or services, and the value net integrator 210 would then retain a percentage of that portion and send the remainder to the organization designated by the supporting party 250. The designation of the supported organization may be maintained directly by the value net integrator 210 in a database in real-time when the supporting party 250 makes its selection, or the third party vendor 230 or search engine partner 240 may receive the organizational designation as part of the transaction and pass the information on to the value net integrator 210 when it remits the required portion.

From the foregoing, it will be understood by persons skilled in the art that an innovative method and system for benefiting a soliciting organization through transactions performed on a global communications system, such as the Internet has been provided. While the description contains many specifics, these should not be construed as limitations on the scope of the invention, but rather as an exemplification of the preferred embodiments thereof. The foregoing is considered as illustrative only of the principles of the invention. Further, because numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

1. A business system for benefitting an organization, the business system on a global communications network comprising computers intercommunicating through communications links, selected computers of the network hosting software representing websites provided for purposes of information and commerce, the websites providing links referencing other websites, so that users may view selected websites through browsers residing on the computers and change viewed websites by referencing the links, the system comprising:
a toolbar for use in conjunction with a browser on a computer, the toolbar being configurable by a value net integrator; and
a database residing on a website of the value net integrator, the database storing transactions made by the user, each transaction identifying the user, a referenced website accessed through the toolbar by the user, and any amount paid to the value net integrator that resulted from the access of the referenced website by the user through the toolbar;
wherein a first contractually specified interface is established between the value net integrator and a search engine partner, such that
the business entity agrees to provide in the toolbar a button invoking a link to the search engine partner, which facilitates the performance of a search transaction by the user using the search engine partner, and
the search engine partner agrees to pay to the value net integrator a royalty based on each transaction made by the user, the transaction resulting from accessing the search engine partner by the user through use of the link to the search engine partner;
and wherein a second contractually specified interface is established between the value net integrator and a soliciting entity, such that
the value net integrator provides to the soliciting entity the toolbar for its use in a soliciting activity performed by the soliciting entity,
the toolbar is provided to the user that wishes to benefit the soliciting entity, and
the value net integrator provides to the soliciting entity a percentage of the royalty provided by the search engine entity.

2. The business system described in claim 1,
wherein a third contractually specified interface is established between the value net integrator and a third party vendor, such that
the value net integrator agrees to provide a button of the toolbar that when pressed provides a link to the third party vendor, which directs the user to the third party vendor for the purchase by the user of goods and services provided by the third party vendor, and
the third party vendor agrees to pay to the value net integrator a royalty based on each sale made to the user that resulted from use of the link to the third party vendor.

3. (canceled)

4. The business system described in claim 2, wherein the toolbar provides a button that directs the browser used by the user to access the third party vendor.

5. The business system described in claim 4, wherein the value net integrator configures the toolbar with one or more features designated by the soliciting entity, each feature selected from a group consisting of a link to the third party vendor, a link to the search engine partner, a link to a chat group, a link to a web site of the soliciting entity, and a pop-up blocker.

6. (canceled)

7. (canceled)

8. The business system described in claim 1, wherein the soliciting entity is selected from the group consisting of a charitable organization, an educational organization, a financial organization, and a sports organization.

9. A method of benefitting a soliciting entity on a global communications network comprising computers intercommunicating through communications links, selected computers of the network hosting software representing websites provided for purposes of information and commerce, the websites providing links referencing other websites, so that users may view selected websites through browsers residing on the computers and change viewed websites by referencing the links, comprising the steps of:
developing a toolbar by a value net integrator, the toolbar containing as a feature a link to the website of a search engine partner;
establishing a first business arrangement between the value net integrator and the soliciting entity, wherein:
the soliciting entity identifies to the value net integrator a set of features to be added to the toolbar;
the value net integrator configures the toolbar with the set of features;
the value net integrator provides to the soliciting entity the configured toolbar for its use in a soliciting activity for the benefit of the soliciting entity;
the value net integrator maintains a database of transactions generated by the features on the toolbar;
the value net integrator receives income from the transactions generated by features on the toolbar; and
the value net integrator provides to the soliciting entity a royalty on the income provided by the search engine entity;
establishing a second business relationship between the value net integrator and a search engine partner, wherein the search engine entity pays the value net integrator a percentage of the income that the search engine partner receives from websites that are selected by the user and that are obligated to pay the search engine partner when a selection is made, the websites being provided to the user as a result of a search request made by the user through the toolbar; and
introducing the toolbar into a stream of commerce;

10. (canceled)

11. The method described in claim 9, wherein the toolbar is configured with one or more features selected from the group consisting of a collection of search buttons, a logo, a friend referral button, a popup blocker enable button, a blocked popup counter, a button linking a vendor's website, a button linking to the soliciting entity's website, and a user registration button.

12. The method described in claim 9, wherein the step of introducing a toolbar into a stream of commerce comprises the steps of
providing access to a downloadable file from a website, wherein the downloadable file contains the toolbar; and
allowing a supporting party to download the downloadable file for incorporation into a supporting party's browser.

13. The method described in claim 12, wherein the website is a web site of the soliciting entity.

14. The method described in claim 12, wherein the website is a web site of the value net integrator.

15. (canceled)

16. The method described in claim 9, further comprising the step of
registering in the database users who have implemented the toolbar.

17. (canceled)

18. (canceled)

19. The method described in claim 16, wherein the step of registering in the database users who have implemented the toolbar is accomplished by pressing the new user registration button on the toolbar.

20. The method described in claim 16, further comprising the step of
establishing a third business relationship between the value net integrator and a third party vendor, wherein
the value net integrator configures the toolbar with the feature consisting of a link to a website of the third party vendor, and
the third party vendor pays as income to the value net integrator a commission that the third party vendor receives from sales of goods and services to the user that result from the user accessing the website of the third party vendor through a feature on the toolbar.

21. The method described in claim 20, the step of establishing the first business relationship further comprising:
the soliciting entity identifies to the value net integrator a set of third party vendors, the links to which are to be added to the toolbar as features;
